(19) United States
(12) Patent Application Publication
(10) Pub. No.: US 2009/0048740 A1
(43) Pub. Date: Feb. 19, 2009

(54) Vehicle safety system including accelerometers

(75) Inventor: Markus Johannes Schiefele, Novi, MI (US)

Correspondence Address: FOLEY AND LARDNER LLP;SUITE 500, 3000 K STREET NW, WASHINGTON, DC, 20007, US

(73) Assignee: TK HOLDINGS INC.

(21) Appl. No.: 11/892,032

(22) Filed: Aug. 17, 2007

(51) Int. Cl. B60R 21/01; G01P 15/18

(52) U.S. Cl. 701/45

(57) ABSTRACT

A system is provided for determining the motion of a vehicle. The system includes a rigid vehicle body having a plurality of accelerometers positioned throughout the vehicle body. The accelerometers are operably connected to a controller for obtaining the accelerometer measurements and estimating the angular velocity, acceleration and angular acceleration at positions throughout the vehicle. Based on theses estimations, the controller determines whether a safety device is activated.

### FIELD OF INVENTION

This disclosure is directed to a system for detecting motion information. Specifically, the disclosure is directed to a system for detecting vehicle motion information for use in vehicle safety applications.

### BACKGROUND

Detecting motion information is a key component in many vehicle applications. For example, angular rate sensors (gyroscopes) can be used in a vehicle system to obtain motion information for the vehicle. This information may be used to activate a safety system such as a seat belt pretensioner, brake control or active steering control. However, gyroscopes are expensive and have proven to be less reliable than accelerometers. Thus, only a limited amount of moderately expensive to expensive vehicles in the marketplace are equipped with gyroscopes. To further complicate matters, maintaining and repairing the gyroscopes is also very expensive. Accordingly, there is a need for a system that uses less expensive sensors, e.g. accelerometers to obtain vehicle motion information such as angular acceleration of the vehicle that is useful in vehicle safety applications.

### SUMMARY

According to one embodiment, a vehicle safety system, includes a safety device, a controller, operably connected to the safety device and a plurality of accelerometers, for obtaining acceleration measurements at positions throughout the vehicle.

According to one embodiment, a vehicle safety system, includes a safety device, a controller, operably connected to the safety device and at least two accelerometers positioned in the vehicle for obtaining acceleration measurements at positions throughout the vehicle, wherein the accelerometers are configured to calculate the directional angular velocity of the vehicle except for the directional angular velocity parallel to a line formed by the accelerometers.

According to another embodiment, a vehicle safety system, includes a safety device, a controller, operably connected to the safety device and at least three accelerometers positioned in the vehicle for obtaining acceleration measurements at positions throughout the vehicle, wherein a plane formed by the accelerometers is not parallel to any axis of a three dimensional Cartesian coordinate system relative to the vehicle.

According to yet another embodiment, a vehicle safety system includes four accelerometers positioned in the vehicle such that the four accelerometers do not lie in the same plane.

It is to be understood that both the foregoing general description and the following detailed description are exemplary and explanatory only, and are not restrictive of the invention as claimed.

### BRIEF DESCRIPTION OF THE DRAWINGS

Features, aspects and advantages of the present invention will become apparent from the following description, appended claims, and the accompanying exemplary embodiments shown in the drawings, which are briefly described below.

FIG. 1 is a block diagram of a vehicle including a multitude of accelerometers coupled to a safety system according to one embodiment.

FIG. 2 shows the positioning of accelerometers in a vehicle, according to one embodiment.

FIG. 3 illustrates the accelerometer positioning in a two accelerometer system, according to one embodiment.

FIG. 4 illustrates the accelerometer positioning in a three accelerometer system, according to one embodiment.

FIG. 5 illustrates the accelerometer positioning in a four accelerometer system.

### DETAILED DESCRIPTION

Embodiments of the present invention will be described below with reference to the accompanying drawings. It should be understood that the following description is intended to describe exemplary embodiments of the invention, and not to limit the invention.

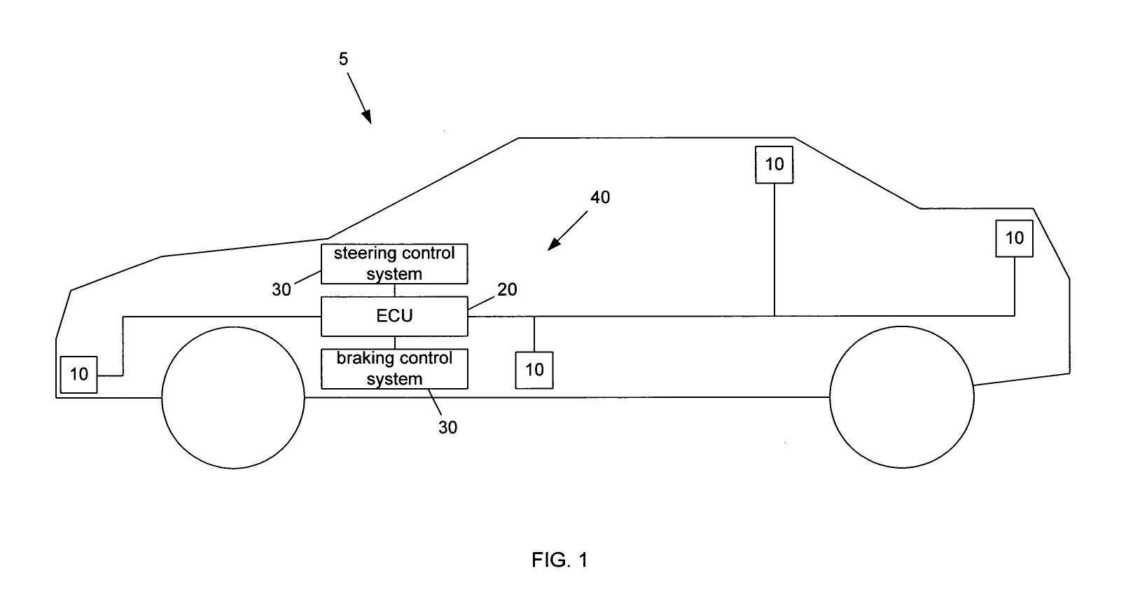

FIG. 1 is a side view of a vehicle 50 including a block diagram of a vehicle safety system, according to one embodiment. The vehicle 50, shown as a sedan, includes a safety system 40 that is configured to measure the acceleration of the vehicle at various points and control one or more safety systems. The vehicle safety system 40 includes a plurality of sensors 10, a controller (ECU) 20 for receiving and interpreting the signals obtained via the plurality of sensors 10 and a safety device 30. The plurality of sensors 10 are preferably accelerometers 10. The accelerometer 10 measures the acceleration of the particular area where it is positioned. The accelerometers 10 can be connected to the ECU 20 via wires or wirelessly. Preferably, the accelerometers 10 are capable of measuring three dimensional acceleration and low amounts of g-force (inertial forces) ranging from 0 to 2 times the acceleration of gravity.

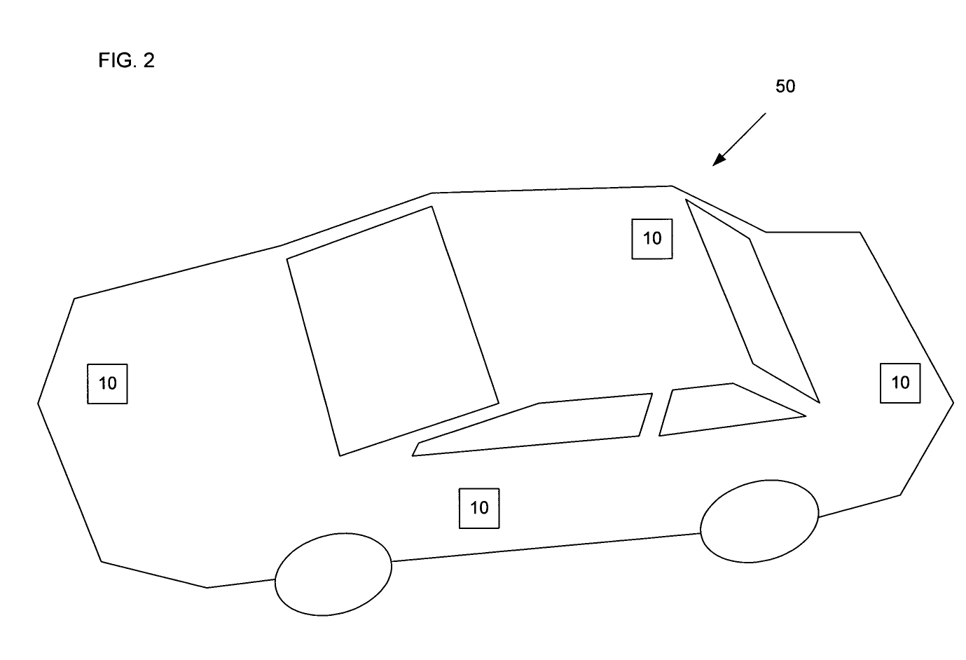

As shown in FIG. 2, the accelerometers 10 may be positioned in various places throughout the vehicle chassis 50. According to one embodiment, the vehicle safety system 40 includes at least two accelerometers 10. According to another embodiment, the vehicle safety system 40 includes three accelerometers 10. Preferably, the vehicle safety system includes four accelerometers 10. The accelerometer 10 information obtained and processed by the ECU 20 may be used to activate the safety device 30. According to one embodiment shown in FIG. 1, the vehicle includes safety device 30 in the form of a steering control system and a brake control system. According to other exemplary embodiments, the vehicle 50 may include a wide variety of active safety systems or a passive safety systems. An example of an active safety system could be one or more of a seat belt pretensioner, brake control, active steering control, a warning light or warning noise generator. An example of a passive safety system could be an airbag, seatbelt, etc.

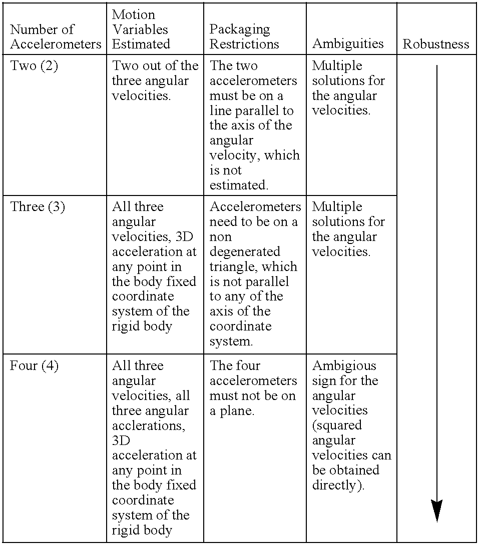

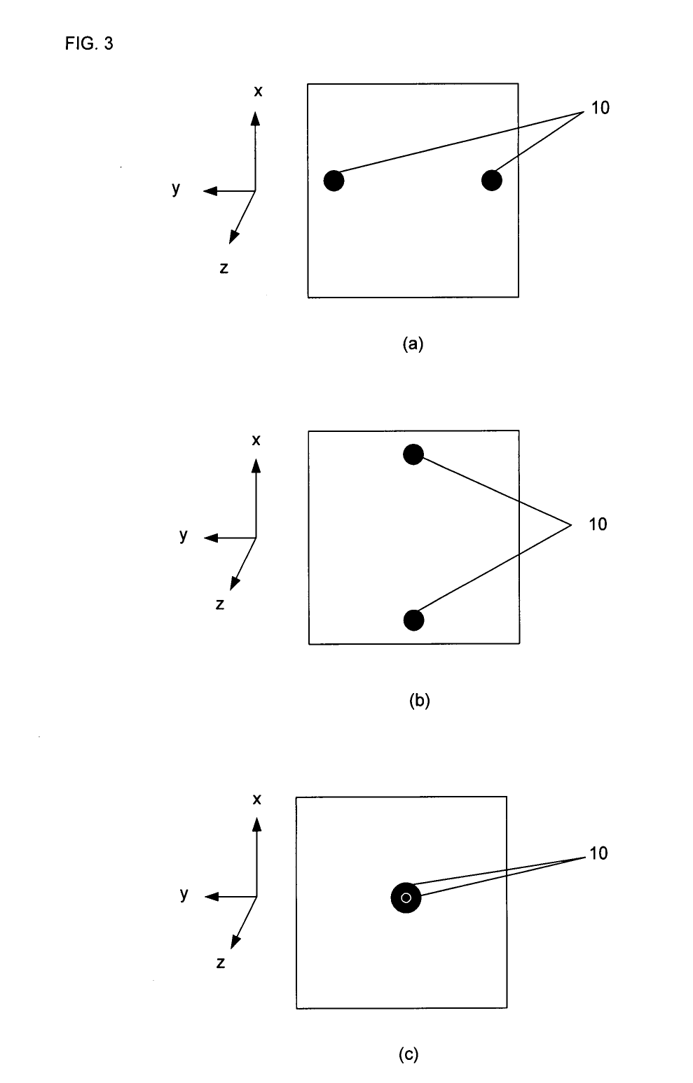

As shown in Table 1, using two accelerometers 10, the system 40 can estimate two out of three directional angular velocities. In the vehicle 50 the two accelerometers 10 must be on a line parallel to the axis of a directional angular velocity. This directional angular velocity will not be estimated. For example, the positioning of the accelerometers 10 in FIG. 3(a) can be used to calculate the yaw and roll rate of a vehicle. Multiple solutions can be obtained for the angular velocities. However, the two accelerometer 10 system is the least robust of the disclosed embodiments. FIG. 2 shows sample configurations for two accelerometers 10 for estimating (a) yaw and roll rate, (b) yaw and pitch rate, and (c) roll and pitch rate.

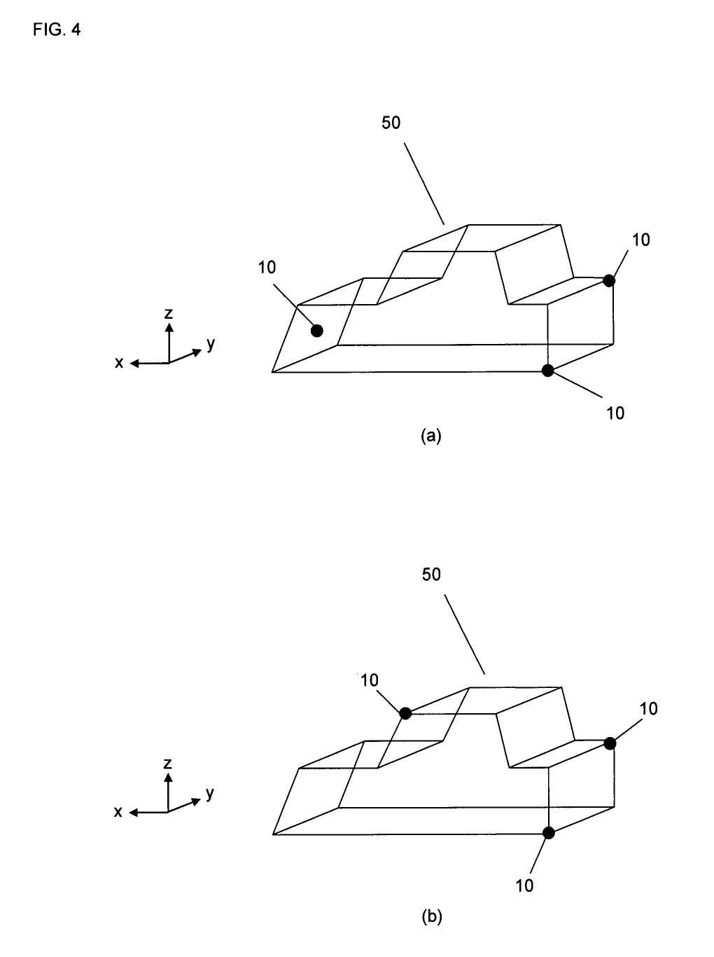

A three accelerometer 10 system is shown in FIG. 4. Specifically, FIG. 4(a) shows an inoperable accelerometer 10 configuration. The configuration of FIG. 4(a) is disadvantageous because the plane formed by the accelerometers 10 is parallel to the x axis. In contrast and according to one embodiment, FIG. 4(b) illustrates a three accelerometer 10 configuration. In a three accelerometer 10 system, all three directional angular velocities can be estimated. The three accelerometer 10 system is more robust than the two accelerometer 10 system. In addition, the system can determine the 3D (three-dimensional) acceleration of the rigid body having the 3 accelerometer 10 system at any point in the body fixed coordinate system. As shown in FIG. 4(b), the accelerometers 10 are mounted in the form of a non degenerated triangle, which is not parallel to any axis of the coordinate system. Multiple solutions can be obtained for the angular velocities.

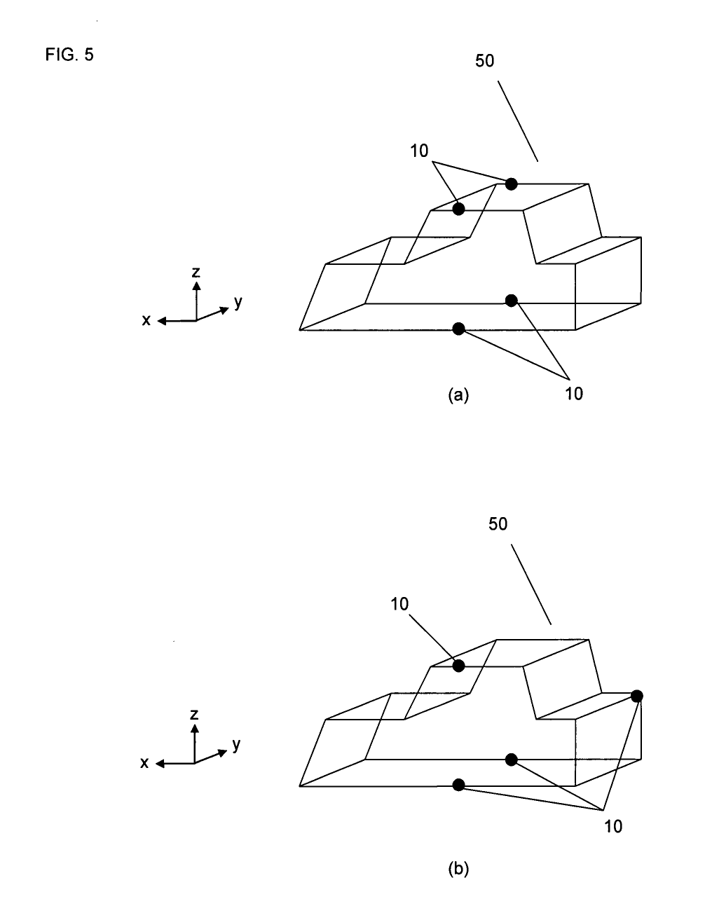

As shown in table 1, in a four accelerometer 10 system, all three directional angular velocities can be determined in addition to all three angular acceleration measurements. Further, the four accelerometer 10 system can determine the 3D (three-dimensional) acceleration of the rigid body having the four accelerometer 10 system at any point in the body fixed coordinate system. A four accelerometer 10 system is shown in FIG. 5. Specifically, FIG. 5(a) shows an inoperable accelerometer 10 configuration. The configuration of FIG. 5(a) is disadvantageous because all four accelerometers 10 are positioned on the same plane which, as shown, is parallel to the z axis. In contrast, as shown in FIG. 5(b), according to one embodiment, the four accelerometers 10 are positioned such that the four accelerometers 10 do not lie in the same plane. In other words, any accelerometer 10 will not lie in the plane formed by the other three accelerometers 10. Accordingly, in this system, angular velocity and acceleration can be obtained directly. The four accelerometer 10 system is the most robust system of the three described above.

Further detail regarding how the vehicle safety system 40 operates is given below. In general, the solutions are obtained by implementing real-time calculations using the equations described below. Before the basic equations of motion can be given, the geometry of the problem needs to be defined. According to one embodiment, we assume the system is attached to, and/or integrated with a rigid body, i.e. a vehicle chassis. The rigid body has an orthonormal coordinate system. Rotation of the rigid body is described by a vector \vec{ω}, where:

$$\vec{ω} = ( \begin{matrix}\dot{ϕ} \\ \dot{ϑ} \\ \dot{ψ}\end{matrix} ) \qquad ( Eqn . 1 )$$

The components \dot{φ}, \dot{θ} and \dot{ψ} describe the angular velocities around the x, y and z axis, respectively. Generally, \dot{φ} is referred to as the roll rate, \dot{φ} is referred to as the pitch rate and \dot{ψ} is commonly referred to as the yaw rate. Acceleration is given by a vector \vec{a}, while speed is defined by a vector \vec{v}, where:

$$\vec{a} = ( \begin{matrix}{a}_{x} \\ {a}_{y} \\ {a}_{z}\end{matrix} ) ; \vec{v} = ( \begin{matrix}{v}_{x} \\ {v}_{y} \\ {v}_{z}\end{matrix} ) \qquad ( Eqn . 2 )$$

In equation 2, the components of vectors \vec{a} and \vec{v} are the acceleration and speeds along the x, y and z axis.

The equations of motion for all points in the orthonormal coordinate frame are given by:

\vec{v}=\vec{v}₀+\vec{ω}×\vec{r} (Eqn. 3)

\vec{a}=\vec{a}₀+\vec{ω}×(\vec{ω}×\vec{r})+{dot over (\vec{ω}×\vec{r}+2\vec{ω}×{dot over (\vec{r} (Eqn. 4)

Equation 4 is the derivative of equation 3. In equation 4, \vec{ω}×(\vec{ω}×\vec{r}) is the centripetal acceleration, {dot over (\vec{ω}×\vec{r} is the precession acceleration and 2\vec{ω}×{dot over (\vec{r} is the coriolis acceleration. Equation 4 shows how acceleration translates on a rigid body (i.e. there is no relative motion between points) from acceleration \vec{a}₀ at one arbitrary point, which is not necessarily the center of gravity, to acceleration \vec{a} at another point, spaced by a vector \vec{r} apart (the same assumption holds for equation (1) in terms of speed). Since the system is integrated with a rigid body, the coriolis term in equation 4 is constantly zero.

Equation 3 is a set of equations linear in \vec{ω}, while equation 4 is a set of differential equations nonlinear in \vec{ω}. In practice, the accelerometers 10 are not optimally calibrated, therefore integrating the acceleration signal is not an option. Drifting will eventually saturate every speed calculation in the system. Accordingly, Equation 3 must be solved after \vec{ω}.

In a four accelerometer 10 system, the angular accelerations can be obtained from equation 4. Any ambiguities can be solved by using equation 3, i.e. integrating the acceleration over the last sampling period to provide a good estimate for the angular velocity, because drifting over this short period of time is negligible. The true solution is then the solution closest to the above-described estimate.

The above-described system has several advantages. The positioning of the accelerometers in the above-described system enables the system to obtain accurate motion data in real-time. Further, accelerometers have been proven to have significantly better long term reliability than gyroscopes. In a system having four accelerometers, a measurement for angular acceleration can be obtained which increases the accuracy and robustness of state estimators which are used by control modules to process the accelerometer information. In addition, the four accelerometer system is a redundant system. If one of the four accelerometers fails, the system can use three accelerometers which still provides a rich set of motion information. Moreover, accelerometer systems are less expensive to implement and maintain which lowers the overall price for high quality vehicle safety systems, thereby increasing the number of lower-priced cars that can be implement the multiple accelerometer system.

The foregoing description of a preferred embodiment of the invention has been presented for purposes of illustration and description. It is not intended to be exhaustive or to limit the invention to the precise form disclosed, and modifications and variations are possible in light of the above teaching or may be acquired from practice of the invention. The embodiment was chosen and described in order to explain the principles of the invention and as a practical application to enable one skilled in the art to utilize the invention in various embodiments and with various modification are suited to the particular use contemplated. It is intended that the scope of the invention be defined by the claims appended hereto and their equivalents.

1-20. (canceled)

21. A vehicle safety system, comprising:
a safety device;
a controller, operably connected to the safety device; and
two accelerometers positioned in the vehicle for obtaining acceleration measurements at positions throughout the vehicle, wherein the accelerometers are configured to calculate the directional angular velocity of the vehicle except for the directional angular velocity parallel to a line formed by the accelerometers.

22. The system of claim 21, wherein the controller receives input from the accelerometers and is configured to calculate the yaw and roll rates of the vehicle.

23. The system of claim 21, wherein the controller receives input from the accelerometers and is configured to calculate the yaw and pitch rate of the vehicle.

24. The system of claim 21, wherein the controller receives input from the accelerometers and is configured to calculate the roll and pitch rates of the vehicle.

25. The system of claim 21, wherein the accelerometers are configured to measure inertial forces ranging from 0 to 2 times the acceleration of gravity.

26. A vehicle safety system, comprising:
a safety device;
a controller, operably connected to the safety device; and
three accelerometers positioned in the vehicle for obtaining acceleration measurements at positions throughout the vehicle, wherein the accelerometers are mounted in the vehicle in the form of a nondegenerated triangle wherein a plane formed by the accelerometers is not parallel to any axis of a three dimensional Cartesian coordinate system relative to the vehicle.

27. The system of claim 26, wherein the controller receives input from each of the three accelerometers and is configured to calculate the yaw, pitch and roll rates of the vehicle.

28. The system of claim 26, wherein the controller receives input from each of the three accelerometers and is configured to calculate the three dimensional acceleration of a point on the vehicle.

29. The system of claim 26, wherein the accelerometers are configured to measure inertial forces ranging from 0 to 2 times the acceleration of gravity.

30. The system of claim 26, wherein the controller is operably connected to the plurality of accelerometers wirelessly.

31. A vehicle safety system, comprising:
a safety device;
a controller, operably connected to the safety device; and
four accelerometers positioned in the vehicle for obtaining acceleration measurements at positions throughout the vehicle, wherein the accelerometers are positioned in the vehicle so that the accelerometers do not lie in the same plane.

32. The system of claim 31, wherein the controller receives input from each of the four accelerometers and is configured to calculate the roll, pitch and yaw rates of the vehicle.

33. The system of claim 31, wherein the controller receives input from each of the four accelerometers and is configured to calculate the raw, pitch and roll accelerations of the vehicle.

34. The system of claim 31, wherein the controller receives input from each of the four accelerometers and is configured to calculate the three dimensional acceleration of a point on the vehicle.

35. The system of claim 31, wherein the accelerometers are configured to measure inertial forces ranging from 0 to 2 times the acceleration of gravity.

36. The system of claim 31, wherein the controller is operably connected to the plurality of accelerometers wirelessly.

37. A vehicle safety system as claimed in claim 1, wherein the safety device is a passive safety system.

38. The system of claim 31, wherein the safety device is an active safety system.
